(19) United States
(12) Patent Application Publication
(10) Pub. No.: US 2007/0280266 A1
(43) Pub. Date: Dec. 6, 2007

(54) METHOD AND APPARATUS FOR PACKET SWITCHING

(75) Inventors: Yun-Fei Chao, Taipei (TW); Chao-Cheng Cheng, Taipei (TW); Wei-Pin Chen, Taipei (TW)

Correspondence Address: THOMAS, KAYDEN, HORSTEMEYER & RISLEY, LLP, 600 GALLERIA PARKWAY, STE 1500, ATLANTA, GA, 30339, US

(73) Assignee: VIA TECHNOLOGIES, INC., Taipei (TW)

(21) Appl. No.: 11/463,021

(22) Filed: Aug. 8, 2006

(30) Foreign Application Priority Data
Jun. 1, 2006 (TW) 95119378

(51) Int. Cl. H04L 12/56

(52) U.S. Cl. 370/395.53

(57) ABSTRACT

A packet switching device simultaneously supports a tagged mode and an untagged mode. A plurality of ports of the packet switching device perform packet delivery and reception, and a port map defines VIDs and operating modes of the ports. Each port operates in tagged or untagged mode, and is associated with at least one VID. The range of VIDs in untagged mode is bounded in a first range, the range of VIDs in tagged mode is bounded in a second range, and the first and second ranges are not overlapped. The plurality of ports comprises a first port operating in untagged mode, associated with a first VID within the first range. The first port receives a first packet, and the packet switching device searches the port map to locate other ports having the first VID and forwards the first packet thereto.

### BACKGROUND OF THE INVENTION

1. Field of the Invention

The invention relates to packet switching, and in particular to a method and apparatus for packet switching supporting both tagged and untagged modes in a virtual local area network (VLAN).

2. Description of the Related Art

FIG. 1 shows a conventional VLAN and a port map thereof. A conventional switch uses a port map as a basis for VLAN management. Each VLAN comprises a unique identification number (Virtual LAN ID; VID). One or more ports on the switch can be associated with the same VLAN by configuring the VIDs thereof. In FIG. 1, the VLAN of VID 0001 associates with port 1, port 2, port 6 and port 8. Basically, one port can only belong to one VLAN, and packets are only transmitted between the ports that belong to the same VLAN. Network nodes distributed in different ports can therefore establish a logical LAN that privately and safely shares packets. If a broadcast packet is input from port 6, the port map is searched to locate other ports that have a VID 0001, which port 6 also has, such as port 1, port 2 and port 8. The switch then replicates the broadcast packet and outputs it to the ports 1, 2 and 8. Additionally, if port 8 is defined as an up link, more than one VID, such as 0001, 0002 and 0003, can be assigned to port 8 in order to broadcast packets, which belong to the three VLANs having VIDs 0001, 0002, and 0003 respectively, to other switches. Thus, VLAN can be implemented as a tree structure by a plurality of switches.

The IEEE 802.11Q standard further defines a tag field embedded in packet headers for VLAN management. The tag field may carry a VID to identify the packet. This is referred to as tagged mode, whereas the conventional protocol on the basis of a port map is referred to as untagged mode. A more flexible VLAN architecture, such as dynamic configuration and VLAN tree structure management, is achieved with tagged mode. Additionally, since every packet comprises a VID, the switch is further able to implement VLAN group management and security filtering rules. Likewise, a port map is required in the switch to record VID of every port. The difference is that every port can belong to more than one VLAN, and the switching policies such as forwarding or discarding are based on the VIDs embedded in the packet headers. Thus, a switch must provide at least one port map, a group table and a filter rule table to support tagged mode.

Tagged mode and untagged mode, however, cannot be simultaneously assigned to one port. A port can only operate in tagged mode or untagged mode at one time. If a port in tagged mode unexpectedly receives an untagged packet, a filter rule may be defined to discard the illegal packet, or to broadcast the packet as is. Conversely, a port in untagged mode may unexpectedly receive a tagged packet. This error is also tolerable, and the packet still can be forwarded according to the port map. Therefore it is possible to implement a switch supporting both tagged and untagged modes, a technical limitation on such a switch. According to the IEEE 802.11Q standard, the VID is stored in a 12-bit field ranging from 1 to 4095. In tagged mode, the VID of each port is assigned by GMRP protocol. Conversely, the VID in untagged mode can only be manually defined. Normally packets of the two different modes do not interflow with each other, but when both modes are simultaneously implemented in one switch, two ports operating in the two different modes may have the same VID in a port map, and expectedly result in the system in confusion. As a result, a packet received from the port in the untagged mode, may be accidentally forwarded to the port that operates in tagged mode and has the VID, which is the same as that of the port in untagged mode, and vice versa. Therefore an improved switch is desirable.

### BRIEF SUMMARY OF INVENTION

A method for packet switching is provided. The method includes the following steps. First, a port map is designed to provide a first table that defines a first group of VIDs (VLAN Identifier) in a first mode, and a second table that defines a second group of VIDs in a second mode, wherein the first mode and the second mode are different, and a set of the first group of VIDs and the second group of VIDs is null. Next, a broadcast packet received from a first port is checked to determine whether the format of the broadcast packet corresponds with the first mode, wherein the first port with a first VID operates in the first mode. Sequentially, at least one port with the first VID is found out by looking up the first table if the format of the broadcasted packet corresponds with the first mode. Finally, the broadcast packet is delivered to at least one port with the first VID.

Another method is provided according to the present invention. The method includes the following steps. First, a port map is designed to provide a first table that defines a first group of VIDs (VLAN Identifier) in a first mode, and a second table that defines a second group of VIDs in a second mode, wherein the first mode and the second mode are different, and a set of the first group of VIDs and the second group of VIDs is null. Next, a broadcast packet received from a first port is checked to determine whether a tag is implemented in the broadcast packet and the format of the broadcast packet corresponds with the second mode, wherein the first port operates in the second mode and the tag includes a specific VID. Sequentially, at least one port with the specific VID is found out by looking up the second table if the format of the broadcasted packet corresponds with the second mode. Finally, the broadcast packet is delivered to at least one port with the specific VID.

The invention also provides a packet switching device. An exemplary embodiment of a packet switching device is capable of simultaneously supporting a tagged and an untagged mode. The packet switching device includes a port map for providing a first table that defines a first group of VIDs (VLAN Identifier) in a first mode, and a second table that defines a second group of VIDs in a second mode, wherein the first mode and the second mode are different, and a set of the first group of VIDs and the second group of VIDs is null, a first port for operating in one of the first mode and the second mode to input or output a broadcast packet, a switcher, which is coupled to the first port, for performing multiplexing to divert the broadcast packet to at least one port, and a controller, which is coupled to the first port, the switcher and the port map, for determining whether the format of the broadcast packet corresponds with one of the first mode and the second mode, and a switching path of the broadcast packet according to the port map.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a conventional VLAN and port map thereof;

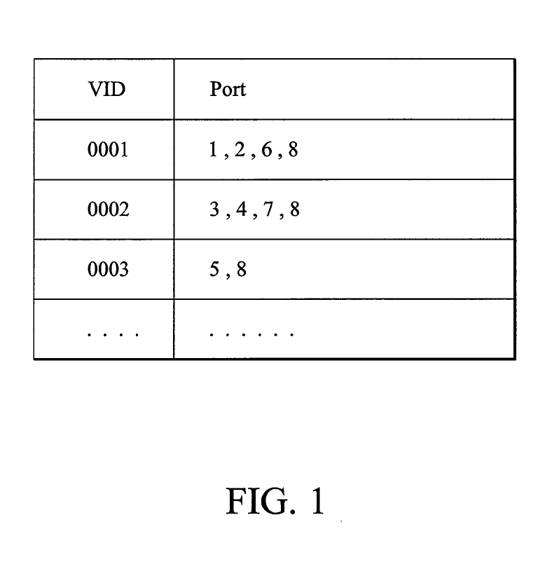

FIG. 2 shows a VLAN supporting both tagged and untagged modes;

FIG. 3 shows an embodiment of a port map according to the invention;

FIG. 4 is a flowchart of the packet switching method in untagged mode according to an embodiment of the invention;

FIG. 5 shows an embodiment of the port map; and

FIG. 6 shows an embodiment of the packet switching device.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

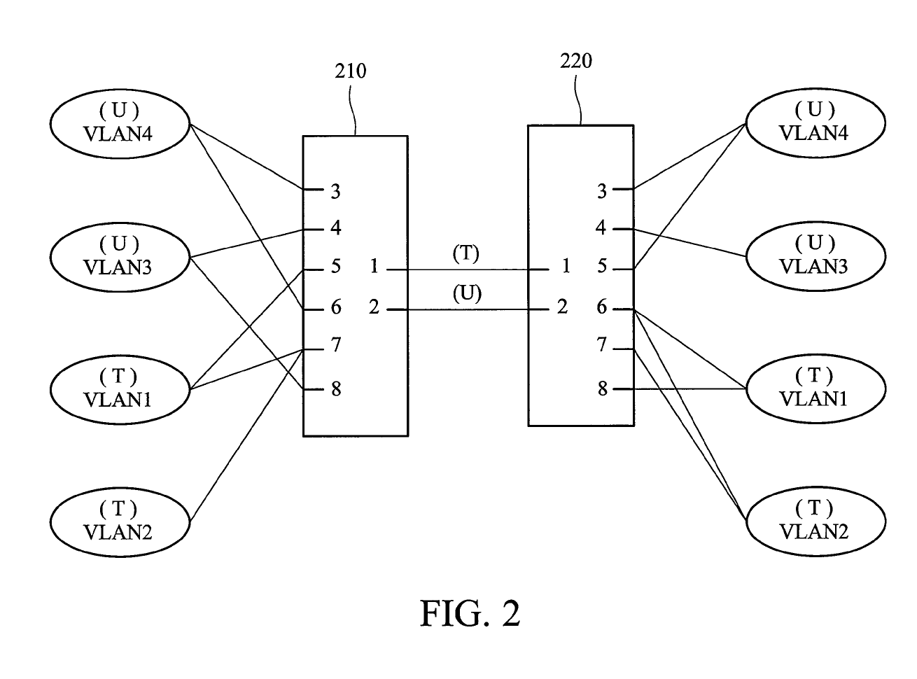

FIG. 2 shows a VLAN supporting both tagged and untagged modes. As an example, two switches are mutually coupled, and each switch individually serves several VLANs via ports 3 to 8 thereof. Port 1 of the first switch 210 and second switch 220 respectively are connected as a bridge for all tagged packets, and port 2 of each is connected as a bridge for all untagged packets. In FIG. 2, VLAN1 and VLAN2 operate in tagged mode, and VLAN3 and VLAN4 operate in untagged mode. Each port of the first switch 210 and second switch 220 belongs to one of the VLANs operating in corresponding modes. FIG. 2 shows only simplified logical circles since the practical connection is a known art.

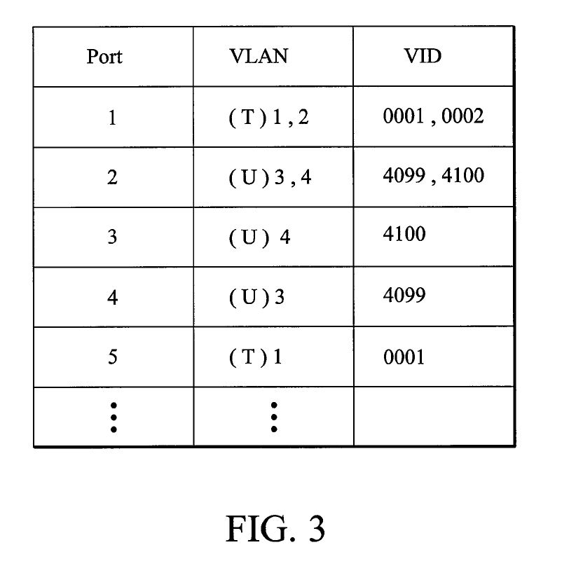

FIG. 3 shows an embodiment of a port map referred to as the configuration of a first switch 210 in FIG. 2. According to the port map, each port is associated with at least one VID and an operating mode. For example, port 5 of the first switch 210 is in tagged mode (T) and has VID 0001 corresponding to VLAN 1. In this embodiment, untagged (U) VIDs are bounded within a first range, and tagged VIDs are within a second range. The first and second ranges do not overlap. Specifically, an identification bit is added to the 12-bit conventional VID for distinguishing the operating mode thereof. Thus, VIDs in the port map are stored as 13-bit digital codes. For tagged VIDs, the first bit is set to 0, so the first range is from 1 to 4095. Likewise, for untagged VIDs, the first bit is set to 1, and the second range is over 4096. Thus, VIDs of the two modes are never confused.

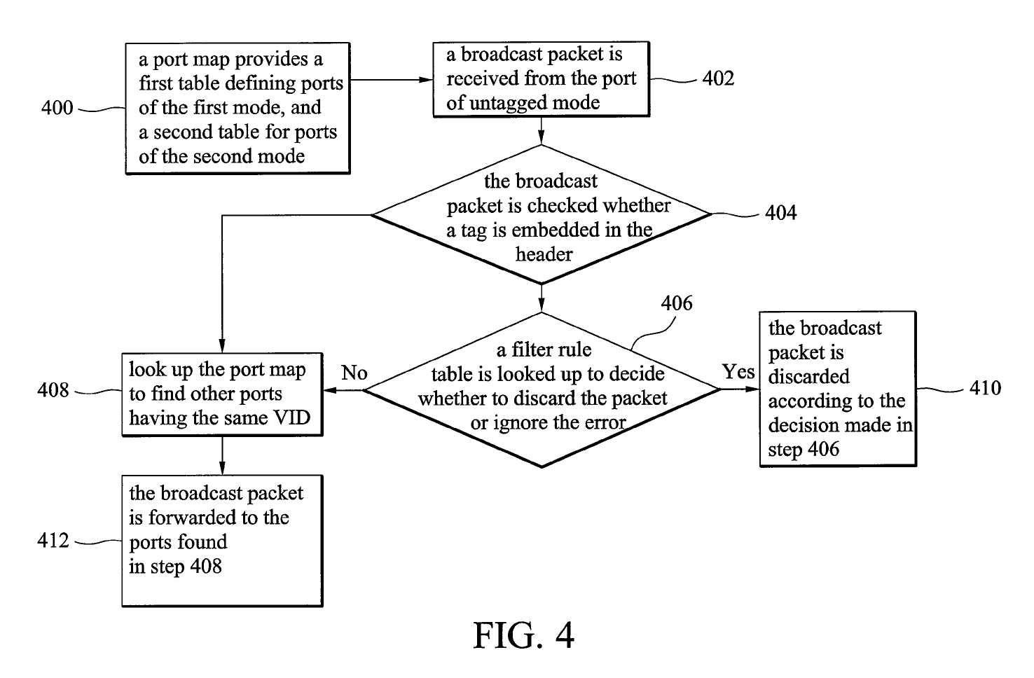

FIG. 4 is a flowchart of the packet switching method in untagged mode according to an embodiment of the invention. First in step 400, a port map provides a first table defining a first group of VIDs (VLAN Identifier) in a first mode, and a second for a second group of VIDs in a second mode. The first mode is untagged mode, and VIDs in the first table are within the first range. The second mode is tagged mode, and VIDs in the second table are within the second range. In step 402, a broadcast packet is received from the port operating in untagged mode. In step 404, it is to be determined that whether a tag is embedded in the header of the broadcast packet. Normally a packet of untagged mode is expected to have no tag, but the switch is not able to predict what will be received, thus, examination is necessary. If the broadcast packet is the packet of untagged mode as expected, In step 408, the port map is looked up to locate other ports having the same VID as that of the port operating in untagged mode. In step 412, the broadcast packet is forwarded to the ports located in step 408. If the broadcast packet is deemed illegal in step 404, a filter rule table is searched to decide whether to discard the packet or ignore the error in step 406. In step 410, the broadcast packet is discarded according to the decision made in step 406. The filter rule table can be configured to meet various security requirements.

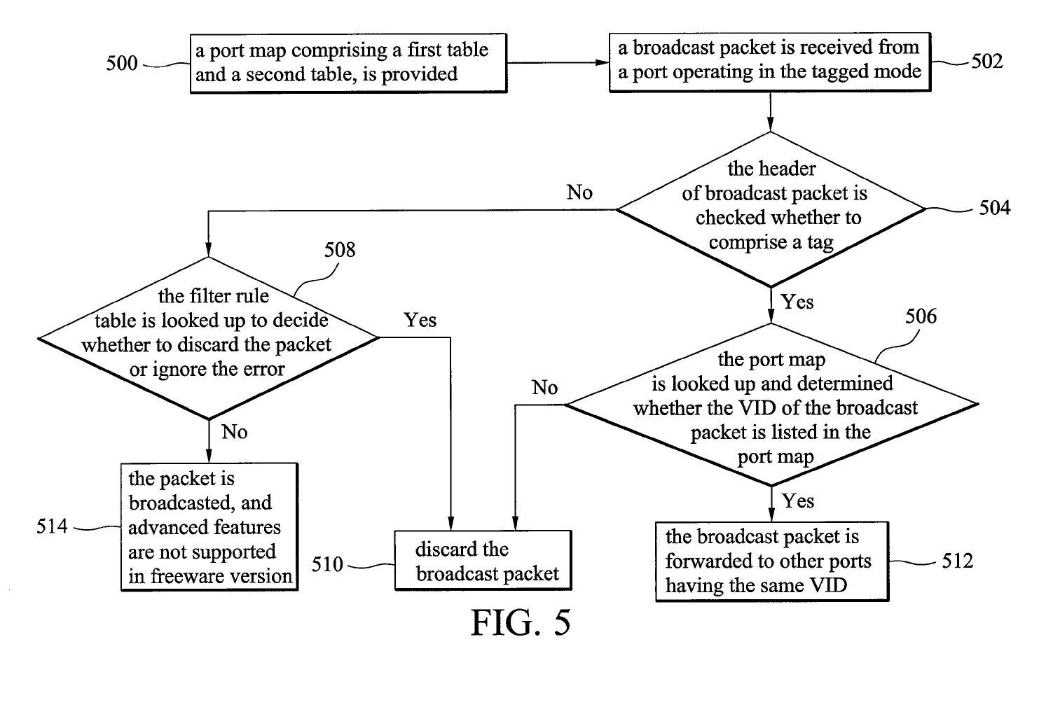

FIG. 5 is a flowchart of the packet switching method in tagged mode according to an embodiment of the invention. In step 500, a port map comprising a first table and a second table, is provided. The definition thereof is the same as step 400 of FIG. 4. In step 502, a broadcast packet is received from a port operating in tagged mode. Referring to FIG. 3, a port map has already associated VIDs for every port. In step 504, it is to be determined that whether the head of the broadcast packet comprises a tag, wherein the tag includes a VID. If the broadcast packet is tagged, go to step 506. Otherwise, the filter rule table is searched in step 508 to decide whether to discard the packet or ignore the error. In step 506, the port map is searched to determine whether the VID of the broadcast packet is listed in the port map. If so, go to step 512, and the broadcast packet is forwarded to other ports having the same VID as that of the broadcast packet. Conversely, if the VID of the broadcast packet is not found out in the port map, go to step 510 to discard the broadcast packet. In step 506, the VID is further registered to the port map according to a registration protocol if the VID is not found out in the second table. If it is decided that the error is to be ignored in step 508, the packet is broadcast in step 514.

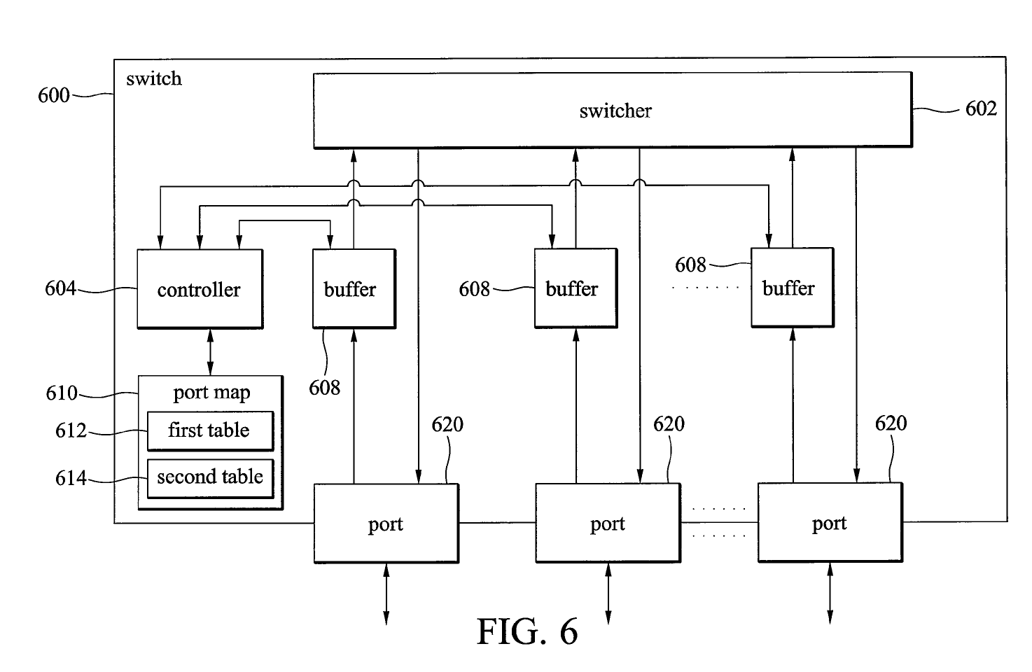

FIG. 6 shows an embodiment of the switch 600. The switch 600 comprises a controller 604, a switcher 602 and a plurality of ports 620. Each buffer 608 corresponding to a port 620, buffers received packets prior to multiplexing in the switcher 602. The controller 604 controls the switcher 602 and all buffers 608 based on a port map 610. The controller 604 also analyzes received packets and searches the port map 610 to control the multiplexing of switcher 602, such that forwarding paths of every packet between the port 620 are determined. The port map 610 may be a program controlled and implemented in a memory device. In the embodiment, the port map 610 comprises a first table 612 and a second table 614, separately recording VIDs of two different operating modes.

The first table 612 defines VIDs of a first mode, and the first mode is an untagged mode in this embodiment. The second table 614 defines VIDs of a second mode, and the second mode is a tagged mode. As an example, a port 620 operates in untagged mode, and the first table 612 associates the port 620 to a first VID. When the port 620 receives a broadcast packet, the controller 604 reads the corresponding buffer 608 to determine whether the format of the broadcast packet corresponds with the untagged mode. If so, the controller 604 searches the second table 614 to locate other ports 620 having the same VID as that of the port operating in untagged mode to forward the broadcast packet. Thereafter, the switcher 602 forwards the broadcast packet to the destination ports 620 by the controller 604. VIDs, which are stored in the first table 612 and the second table 614, are digitalized over 12 bits. VIDs in the first table 612 and second table 614 have different ranges, and a set of the VIDs in the first table 612 and second table 614 is null Thus confusion will not occur.

As another example, for a port 620 operating in tagged mode, when a broadcast packet is received, the controller 604 reads it via the buffer 608 and determines whether a tag is embedded therein. Normally the tag comprises at least one VID, and controller 604 searches the second table 614 for the VID to determine destination ports 620. A tagged packet may comprise more than one VID, and belongs to several VLANs. The second table 614 stores a record of every VID associated port 620 in tagged mode. Port 620 may also belong to more than one VLAN, and has more than one VID. The switcher 602 establishes forwarding paths to deliver the broadcast packet to ports 620 having the same VID as that of the broadcast packet according to the second table 614 by the controller 604.

If the VID cannot be located in the second table 614, the broadcast packet can be discarded. Alternatively, a registration protocol can be performed to register the VID to the second table 614, and thus the source port 620 is associated with the VID. A filter rule table is provided to determine whether to discard or to register VIDs. If a port 620 operating in tagged mode receives an untagged broadcast packet, the filter rule table is also used to decide whether to discard or to broadcast the packet to other ports 620 having the same VID as that of the broadcast packet. This embodiment provides a port map 610 comprising a first table 612 and second table 614 having different ranges, and the confusion is efficiently solved when both tagged and untagged modes are supported.

The first switch 210, second switch 220 and switch 600 described in the specification are not the only possible embodiments. The total number of ports is not limited to 8, and the network topology may have many variations. The format of the port map is not constrained to that shown in FIG. 3. The key feature is to eliminate confusion by differentiating between and separating the tagged and untagged modes.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A packet switching method for virtual local area networks (VLANs), comprising:
designing a port map to provide a first table that defines a first group of VIDs (VLAN Identifier) in a first mode, and a second table that defines a second group of VIDs in a second mode, wherein said first mode and said second mode are different, and a set of said first group of VIDs and said second group of VIDs is null;
checking a broadcast packet received from a first port to determine whether the format of said broadcast packet corresponds with said first mode, wherein said first port with a first VID operates in said first mode;
finding out at least one port with said first VID by looking up said first table when the format of said broadcasted packet corresponds with said first mode; and
delivering said broadcast packet to at least one port with said first VID.

2. The packet switching method as claimed in claim 1, wherein said first mode is an untagged mode, said second mode is a tagged mode, and said first group of VIDs and said second group of VIDs are both digitized over 12 bits.

3. The packet switching method as claimed in claim 1, wherein said first group of VIDs and said second group of VIDs are both digitized in 13 bits, and the range of said first group of VIDs digitized in 13 bits is over 4096 and the range of said second group of VIDs digitized in 13 bits is from 1 to 4095.

4. The packet switching method as claimed in claim 1, wherein the method further comprises:
conforming said broadcast packet to said first mode when no tag is found in the header of said broadcast packet; and
conforming said broadcast packet to said second mode when a tag is found in the header of said broadcast packet.

5. The packet switching method as claimed in claim 1, wherein the method further comprises:
providing a filter rule table to decide transfer policies when the format of said broadcast packet corresponds with said second mode; and
discarding said broadcast packet according to said filter rule table when the format of said broadcast packet corresponds with said second mode.

6. The packet switching method as claimed in claim 1, wherein the method further comprises:
providing a filter rule table to decide transfer policies when the format of said broadcast packet corresponds with said second mode; and
ignoring an error of the format to look up said first table according to said filter rule table when the format of said broadcast-packet corresponds with said second mode.

7. A packet switching method for virtual local area networks (VLANs), comprising:
designing a port map to provide a first table that defines a first group of VIDs (VLAN Identifier) in a first mode, and a second table that defines a second group of VIDs in a second mode, wherein said first mode and said second mode are different, and a set of said first group of VIDs and said second group of VIDs is null;
checking a broadcast packet received from a first port to determine whether a tag is implemented in said broadcast packet and the format of said broadcast packet corresponds with said second mode, wherein said first port operates in said second mode and said tag comprises a specific VID;
finding out at least one port with said specific VID by looking up said second table when the format of said broadcasted packet corresponds with said second mode; and
delivering said broadcast packet to at least one port with said specific VID.

8. The packet switching method as claimed in claim 7, wherein said first mode is an untagged mode, said second mode is a tagged mode, and said first group of VIDs and said second group of VIDs are both digitized over 12 bits.

9. The packet switching method as claimed in claim 7, wherein said first group of VIDs and said second group of VIDs are both digitized in 13 bits, and the range of said first group of VIDs digitized in 13 bits is over 4096 and the range of said second group of VIDs digitized in 13 bits is from 1 to 4095.

10. The packet switching method as claimed in claim 7, wherein the method further comprises:
conforming said broadcast packet to said first mode when no tag is found in the header of said broadcast packet; and
conforming said broadcast packet to said second mode when a tag is found in the header of said broadcast packet.

11. The packet switching method as claimed in claim 1, wherein the method further comprises:
providing a filter rule table to decide transfer policies when the format of said broadcast packet corresponds with said first mode; and
discarding said broadcast packet according to said filter rule table when the format of said broadcast packet corresponds with said first mode.

12. The packet switching method as claimed in claim 1, wherein the method further comprises:
providing a filter rule table to decide transfer policies when the format of said broadcast packet corresponds with said first mode; and
ignoring an error of the format to look up said second table according to said filter rule table when the format of said broadcast packet corresponds with said first mode.

13. The packet switching method as claimed in claim 7, wherein the method further comprises discarding said broadcast packet when said specific VID is not found in said second table.

14. The packet switching method as claimed in claim 7, wherein the method further comprises registering the VID in said second table through a registration protocol when said specific VID is not found in said second table.

15. A packet switching device, adopted in virtual local area network (VLAN), comprising:
a port map for providing a first table that defines a first group of VIDs (VLAN Identifier) in a first mode, and a second table that defines a second group of VIDs in a second mode, wherein said first mode and said second mode are different, and a set of said first group of VIDs and said second group of VIDs is null;
a first port for operating in one of said first mode and said second mode to input or output a broadcast packet;
a switcher, which is coupled to said first port, for performing multiplexing to divert the broadcast packet to at least one port; and
a controller, which is coupled to said first port, said switcher and said port map, for determining whether the format of said broadcast packet corresponds with one of said first mode and said second mode, and a switching path of said broadcast packet according to said port map.

16. The packet switching device as claimed in claim 15, wherein said first mode is an untagged mode, said second mode is a tagged mode, and said first group of VIDs and said second group of VIDs are both digitized over 12 bits.

17. The packet switching device as claimed in claim 15, wherein said first group of VIDs and said second group of VIDs are both digitized in 13 bits, and the range of said first group of VIDs digitized in 13 bits is over 4096 and the range of said second group of VIDs digitized in 13 bits is from 1 to 4095.

18. The packet switching device as claimed in claim 15, wherein:
a first VID tagged on said first port is stored into said first table when said broadcast packet is inputted into said first port operating in said first mode;
said controller checks whether the format of said broadcast packet corresponds with said first mode;
said controller looks up said first table to find out at least one port with said first VID when the format of said broadcast packet corresponds with said first mode; and
said switcher transmits said broadcast packet to at least one port by said controller.

19. The packet switching device as claimed in claim 15, wherein:
said controller identifies whether a head of said broadcast packet comprises a tag;
said broadcast packet corresponds with said first mode when said tag is not found in said head; and
said broadcast packet corresponds with said second mode when said tag is found in said head.

20. The packet switching device as claimed in claim 15, further comprising a filter rule table for deciding transfer policies, which are that said controller discards said broadcast packet according to said filter rule table when the format of said broadcast packet is inconsistent with the operating mode of said first port.

21. The packet switching device as claimed in claim 15, further comprising a filter rule table for deciding transfer policies, which are that said controller ignores an error of the format of said broadcast packet according to said filter rule table when the format of said broadcast packet is inconsistent with the operating mode of said first port.

22. The packet switching device as claimed in claim 15, wherein:
a tag is labeled in said broadcast packet and comprises a VID when said first port receives said broadcast packet and operates in said second mode;
said controller examines whether the format of said broadcast packet corresponds with said second mode; and
said controller looks up said second table to find out at least one port, and said switcher forwards said broadcast packer to at least one port by said controller when the format of said broadcast packer corresponds to said second mode.

23. The packet switching device as claimed in claim 22, wherein said controller discards said broadcast packet when said VID is not found in said second table.

24. The packet switching device as claimed in claim 22, wherein said controller registers said VID into said second table according to a registration protocol when said VID is not found in said second table.
